(19) United States
(12) Patent Application Publication
(10) Pub. No.: US 2004/0103772 A1
(43) Pub. Date: Jun. 3, 2004

(54) Machine for piercing sheets of material in a variety of patterns using an adjustable apparatus

(76) Inventor: Diana Amelia Normington, Gilbert, AZ (US)

Correspondence Address: PETER J.C. HORMINGTON, 516 COUNTRY PLAZA SOUTH, GILBERT, AZ, 85234, US

(21) Appl. No.: 10/701,873

(22) Filed: Nov. 5, 2003

Related U.S. Application Data
(60) Provisional application No. 60/426,141, filed on Nov. 13, 2002.

(51) Int. Cl. B26D 5/08

(52) U.S. Cl. 83/588; 83/646

(57) ABSTRACT

A machine for piercing sheets of material with an adjustable apparatus, acting as a stop to the moveable cutting die thereby varying the amount of the punch pattern cut into a sheet of material being punched. The moveable cutting die is designed with a cutting surface so that the adjustable apparatus can vary the amount and pattern of that die cut by the cutting surface into the sheet of material. A frame holds the adjustable apparatus, the moveable punch cutting die and a hole aligned to the moveable cutting die with the hole allowing motion of the moveable cutting die. A slot in the frame extending partially through the frame accepts and restrains the sheet of the material. A hand actuated assembly activates the moveable cutting die moving the cutting die to where it contacts and cuts the sheet of the material in the slot.

### CROSS REFERENCE TO RELATED APPLICATIONS

This application is based on provisional application serial No. 60/426,141, filed on Nov. 13, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of arts and crafts specifically paper punching and more specifically to a machine for piercing sheets of material in a variety of patterns using an adjustable apparatus.

The use of hand actuated paper punches has a long history of use both for business and for various types of arts and crafts. Paper punches are used to form shapes in paper by cutting away a section of the paper using a cutting die designed to make a smooth cut and further designed with a specific geometry for that cut. Along with the cutting die, paper punches use a matching hole on the other side of the paper being punched to allow the cutting die to pass completely through the paper while the hole and base of the frame with the hole hold and support that paper. The hole must be closely matched to the size and geometry of the cutting die to provide for a smooth cut. In addition, the cutting die must be manufactured with a set of edges that form the cutting surface and are located at an angle to the paper being punched to also insure a smooth cut.

The initial use for paper punching was to punch circular holes in paper that was then mounted in binders with a corresponding rings to hold that paper. Such binders usually with three rings to hold the paper are in wide use throughout the world in business. Similar punches are used in schools to compile the work pages of students.

Soon various artists realized that the cutting die or paper punches could be designed in various geometries and shapes to form special cutouts such as stars, circles and a myriad of other shapes and items. Currently there are a large variety of decorative paper punches used in a number of arts and crafts.

The configuration of the punch itself changed. Initially, paper punches looked much like a pair of pliers where the mechanism was held in the hand and paper placed between the cutting die and the base and then the handles squeezed to punch the paper. A spring was placed between the handles to return the punch to the open position when the punching operation was completed. Three hole punches often used a lever to allow the user to push down on that lever and move the three cutting dies down and punch through the paper with a spring again returning the punch to the open position after the paper was punched.

Then the punch configuration changed to a button attached to the cutting die and held along with the return spring in a frame. A slot was provided in the frame to insert the paper to be punched and the button was pushed down to punch the designed pattern into that paper.

The next configuration for the paper punches uses a thumb-actuated lever to push down on the cutting die and punch out the pattern. This configuration is contained in U.S. Pat. No. 5,749,278.

Both the push button punch and the thumb-activated lever punch are produced in a large variety of patterns by a number of suppliers. They are used in the arts and crafts industry in a number of applications. The punches vary in size as well as the pattern to be punched. As punches grew in size, it became more difficult to push on the push button to punch through the paper. Helper systems were developed to assist in the use of the larger punches and to make it easier to punch a large number of patterns. These helpers are hinged arms that hold the punch and provide more leverage to the user of avoid fatigue and to punch larger patterns.

Although the punches were originally designed and are still labeled as paper punches, various users found that these punches could be used to punch patterns in a variety of materials in sheet form. These include: coated papers, plastic sheets, metallic foil sheets, special clays, leathers and others. As long as the material was in a sheet form thin enough to fit into the punch, it could be punched into the pattern designed into that punch.

The major problem with all existing punches is the lack of flexibility. The punch can only punch out the designed pattern. The resulting piece can then be used as a decorative element in some type of craft and/or the resulting hole in the sheet of material could be the decorative element. There was no way, for example, that a flower pattern could be partially punched out of a sheet of material with the, petals cut out, but the center left in the sheet of material.

### BRIEF SUMMARY OF THE INVENTION

The primary object of the invention is to provide an adjustable decorative punch that partially punches out a pattern in a sheet of material when properly adjusted. This punch can also be adjusted to fully punch out the pattern as with existing punches. With this punch, it would be possible to partially punch out a flower pattern leaving the center attached to the sheet of material and the petal cut free. This would then provide a new and large variety of possible arts and crafts projects using this invention.

Another object of the invention is to make the adjustable apparatus easy to use, precise and easily manufactured using the same materials as used to make existing punches.

Another object of the invention is to allow the adjustable punch to be used with a variety of material types, thickness and qualities.

A further object of the invention is to provide an adjustable apparatus that will work with all of the currently available punch configurations and could be provided as a retrofit kit to existing punches.

Still yet another object of the invention is to provide a reliable and cost effective adjustable apparatus.

Other objects and advantages of the present invention will become apparent from the following descriptions, taken in connection with the accompanying drawings, wherein, by way of illustration and example, an embodiment of the present invention is disclosed.

There is disclosed a machine for piercing sheets of material with an adjustable apparatus that can be moved by hand where the adjustable apparatus acts as a stop to the moveable cutting die containing the punch pattern thereby varying the amount of the punch pattern cut into a sheet of material being punched. The moveable cutting die is designed with a cutting surface so that the adjustable apparatus can limit the amount of the sheet of said material cut by the cutting surface. The adjustable apparatus can also be moved to a position so that the designed pattern of said punch is cut fully out of a sheet of material by the movement of the moveable cutting die. There is a frame which holds the adjustable apparatus and the moveable punch cutting die with the moveable cutting die held in the top of the frame and a hole aligned to the moveable cutting die in the base of the frame.

In accordance with a preferred embodiment of the invention, there is disclosed an adjustable apparatus that can be added to existing decorative punches where the adjustable apparatus acts as a stop to the moveable cutting die containing the punch pattern.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of one variation of the invention showing a push button type of punch.

FIG. 2 is a perspective view of the variation of the invention shown in FIG. 1.

FIG. 3 is a side view of another variation of this invention with a punch assist device added to the push button type of punch.

FIG. 4 is a cross section view of another variation of the invention with multiple slots for the sheet of material.

FIG. 5 is a side view of another variation of the invention where the punch action is activated by a lever.

FIG. 6 is a perspective view of the variation of the invention shown in FIG. 5.

FIG. 7 is a side view of still another variation of the invention where the punch action is achieved by squeezing the handles held in the hand.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

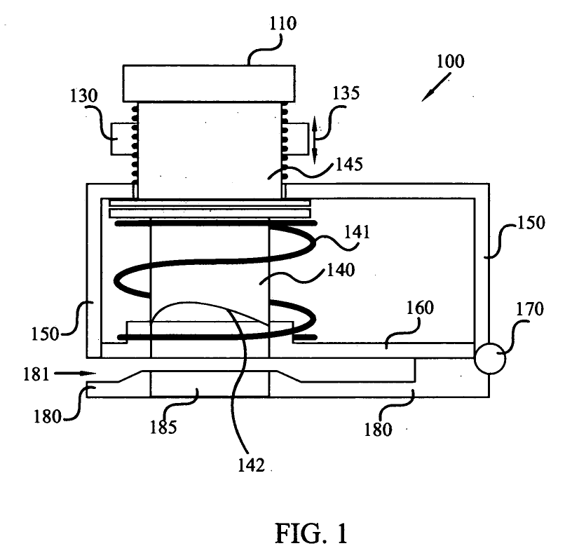

A preferred embodiment of the invention is shown in FIG. 1 where the threaded push button 145 of a machine 100 also has a matching threaded ring 130 placed on this threaded push button 145 forming an adjustable stop 135. The threaded ring 130 and the threaded push button 145 together comprise an adjustable apparatus. The threaded ring 130 can be rotated around the threaded push button 145 moving up and down the threaded push button 145 and thereby limiting the motion of the threaded push button 145. As the threaded push button 145 is pushed downward using the top 110 it pushes down a moveable cutting die 140 with a cutting surface 142 designed to cut a particular pattern into a sheet of material held in the slot 181. The cutting surface 142 is at an angle to the sheet of material to make a sharp and uniform cut through that sheet of material. The hole 185 at the lower portion 180 of the machine 100 matches the particular pattern of the moveable cutting die 140 which also assists in making a sharp and uniform cut. Because of the angles formed on the cutting surface 142 of the moveable cutting die 140 and the ability to use the threaded ring 130 to limit the motion of the push button 145, it is possible to have the machine 100 only cut out a portion of the particular pattern designed into the cutting surface 142 of the moveable cutting die 140. This leaves the sheet of material pierced with a part of the particular pattern of the cutting surface 142 of the moveable cutting die 140. For example, if the particular pattern was a flower, then the sheet of material might have only the petals of that flower design cut into that sheet of material. The threaded adjustable ring 130 and the threaded push button 145 are manufactured so that the threaded adjustable ring 130 can be placed in a position so that the complete particular pattern can be fully punched out of the sheet of material if so desired.

In the view shown in FIG. 1 can be seen more detail of the construction where a spring 141 is used to return the moveable threaded push button 145 to the original starting position following the piercing or punching of a sheet of material. Once that sheet of material is processed as desired, then it can be removed from the slot 181 by rotating the base 180 of the machine 100 using the hinge 170 thereby freeing up the sheet of material for easy removal. The slot 181 is designed to accept a variety of thickness of sheets of material while the cutting surface 142 of moveable cutting die 140 is designed to cut a variety of materials. The upper portion 160 and the lower portion 180 hold and align the moveable cutting die 140 and the matching hole 185 and form a frame. A housing 150 completes the machine 100 and secures the threaded push button 145 against the action of the spring 141.

It can be noted in FIG. 1, that the cutting surface 142 is manufactured with that cutting surface 142 at an angle to the sheet of material being processed. This feature is common to all such machines and is similar in operation to the angled cutting action seen in a pair of scissors as they are used to cut. The cutting surface 142 can be formed in a straight line at an angle to the sheet of material or as a curved surface at an angle to the sheet of material.

The hole 185 in the lower portion 180 as illustrated in FIG. 1 is also critical to a smooth and sharp cut. That hole 185 must duplicate the pattern in the moveable cutting die 140 so that the cutting die 140 fits precisely into the hole 185 thereby providing the necessary shearing action like a pair of scissors.

In operation a sheet of material is placed in the machine 100 and the top 110 of the threaded push button 145 depressed with the threaded ring 130 at its highest point on the threaded push button 145. The amount of the machine 100 pattern cut into that sheet of material is monitored by slowly pushing down on the threaded push button 145 until the desired cut in that sheet of material is achieved. Then the threaded ring 130 is turned down along the threaded push button 145 until it stops any further downward motion of that push button 145. It may take several iterations until the desired effect is achieved by the user. Once that final adjustment is made with the threaded ring 130, then other sheets of material can be processed by the machine 100. At any time, the threaded ring 130 can be moved to another position and a different amount of the pattern of the machine 100 cut into a sheet of material.

Once a cut has been made, it is necessary to remove or move the sheet of material for another cut. Since the sheet of material may be only partially cut, removal is difficult with the cut portions of the sheet of material caught up in the hole. One solution as shown in FIG. 1 is a hinge 170 that can release the lower portion 180 of the machine 100 thereby making removal of the sheet of material easy. Another embodiment would be to make the base capable of being snapped apart to ease the removal of that sheet of material. Still another option would be no hinge 170 or no ability to snap apart the machine 100. Then the user would carefully push down on the cut portion of the sheet of material and then remove it from the machine 100.

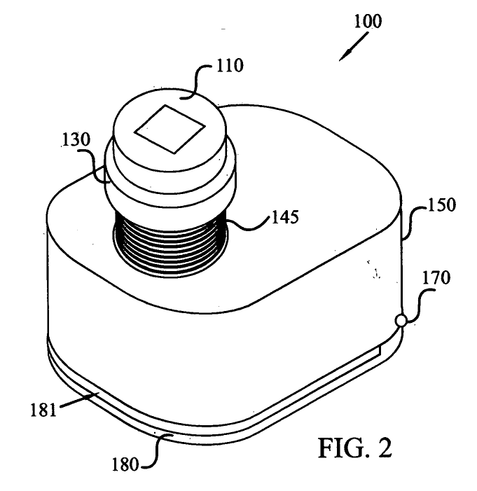

FIG. 2 shows an external view of the machine 100 where the key feature of the threaded push button 145 and the matching threaded ring 130 can be easily seen and compared with prior art paper punches which do not have such features.

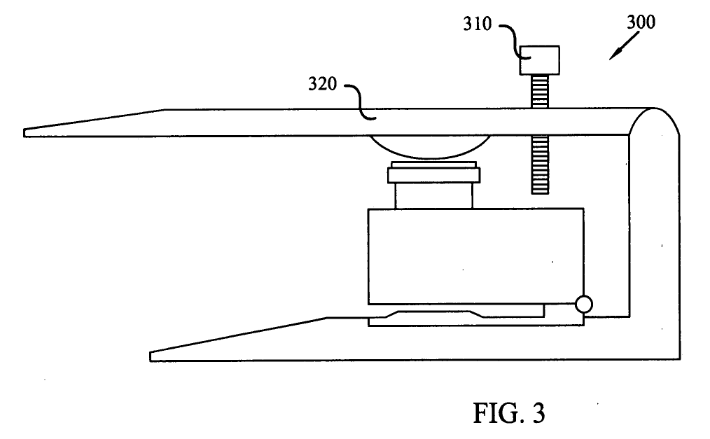

As prior art punches have been developed and gotten bigger, the craft industry has developed aids to make it easier to use such punches. These aids are important for large punches or for punching stronger sheets of material. Such aids consist of an assembly where the punch is placed inside and the assembly has a long base and a long moveable arm which the user uses to push down on the push button of a prior art punch. The long arm increases leverage and makes the prior art punch easier to use. FIG. 3 illustrates the concept of this invention applied to such an aid where an adjustable threaded element 310 is added to the aid 300 which has corresponding threads manufactured into that aid 300 thereby forming an adjustable apparatus. This machine 300 allows for conventional prior art punches to have an adjustable feature. In use the prior art punch is placed in the machine 300 and the moveable arm 320 pushed down on the prior art punch. The adjustable threaded element is then turned to form a stop to the motion of the moveable arm 310 thereby controlling the motion of the prior art punch and establishing the adjustable feature of his invention.

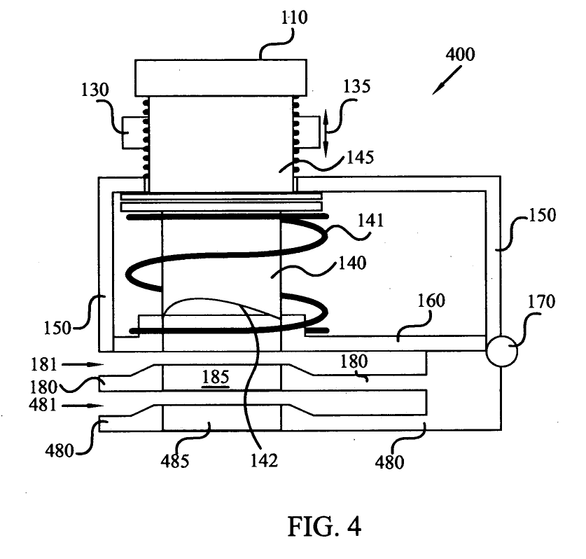

FIG. 4 shows another embodiment of the invention where a second slot 481 below the first slot 181 has been added to the machine 100 shown in FIG. 1 along with a second lower portion 480 below the first lower portion 180 and a second hole 485 below the first hole 185 thereby forming a new machine 400. With this configuration, the first slot 181 can be used to hold a sheet of material where the pattern of the machine 400 is completely punched out while the second slot 481 is used to hold a sheet of material where the pattern is only partially punched and the machine 400 is used as described above in the operation of machine 100 with all of the features and options previously described.

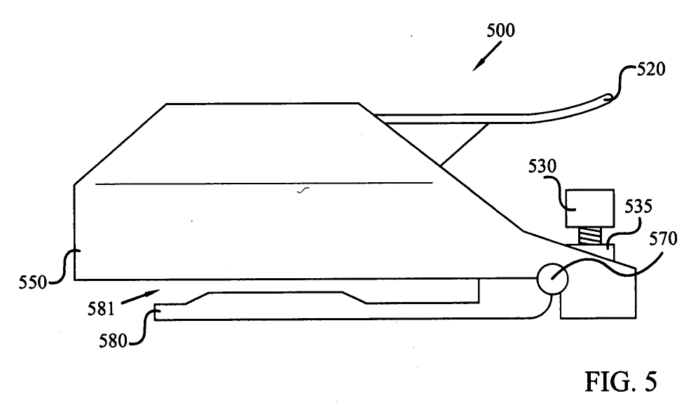

As the field of paper punches has evolved, a new style of punch has been developed. This style is shown in U.S. Pat. No. 5,749,278. This punch uses a thumb actuated lever to create the action of the punch. The adjustable apparatus of the invention can be seen in FIG. 4 where a threaded element 530 has been incorporated into a thumb actuated punch thereby forming machine 500. A matching threaded portion 535 is incorporated into the housing 550 where the threads of that portion 535 match to those of threaded element 530 and thereby form the adjustable apparatus of the invention. In use a sheet of material is placed in the slot 581 and the lever 520 pushed down to actuate the punch. The threaded element 530 is then turned either up or down to form a stop to the action of the punch and cut the desired pattern into the sheet of material. As shown in FIG. 5 a hinge 570 is incorporated into machine 600 to allow for the lower portion 580 to be moved away from the housing 550. This then makes removal of the sheet of material easier. As an option the punch could be manufactured with a snap apart lower portion 580 or with that lower portion 580 fixed to the housing 550.

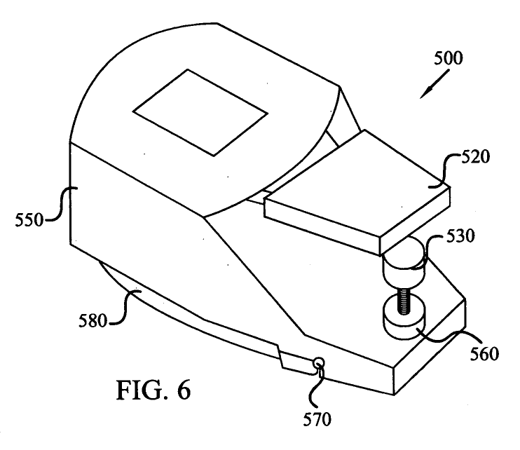

FIG. 6 shows another view of the invention where a threaded part 560 is added as a retrofit to a previously manufactured thumb actuated punch. The operation of the machine 500 is otherwise identical to that described above.

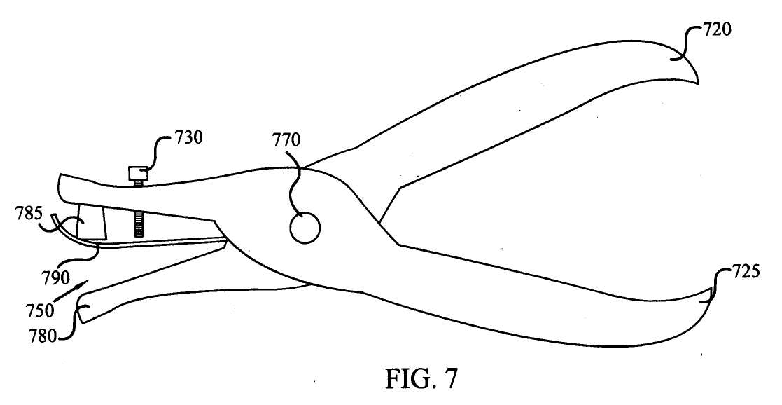

FIG. 7 shows another embodiment of the invention where the adjustable element 730 is incorporated into a punch where a sheet of material is placed into slot 750 and the upper handle 720 and the lower handle 725 are squeezed together rotating around hinge 770 pushing the cutting die 785 through a matching hole in the center support 790 and on through the sheet of material and a corresponding hole in the lower portion 780. The adjustable element 730 is turned up or down to form the desired pattern in the sheet of material. That adjustable element 730 moves through a hole in the center support 790 when the upper handle 720 and lower handle 725 are squeezed and stops when it contacts the lower portion 780. The adjustable element 730 and the lower portion 780 form the adjustable apparatus of this invention.

While the figures have shown threaded elements to form the adjustable stops of this invention, there are other possible ways to form such stops as would be obvious to anyone skilled in the art. This could include items such as shims of various thickness which would be particularly appropriate for the thumb actuated punches.

While the invention has been described in connection with a preferred embodiment, it is not intended to limit the scope of the invention to the particular form set forth, but on the contrary, it is intended to cover such alternatives, modifications, and equivalents as may be included within the spirit and scope of th invention as defined by the appended claims.

What is claimed is:

1. A machine for piercing sheets of material comprising:
an adjustable apparatus that can be moved by hand;
the adjustable apparatus acts as a stop to the moveable cutting die containing the punch pattern thereby varying the amount of the punch pattern cut into a sheet of material being punched;
the moveable cutting die is designed with a cutting surface so that said adjustable apparatus can limit the amount of said sheet of said material cut by said cutting surface;
the adjustable apparatus can be moved to a position so that said designed pattern of said punch is cut fully out of said sheet of said material by the movement of said moveable cutting die;
a frame which holds said adjustable apparatus and said moveable punch cutting die with said moveable cutting die held in the top of said frame and a hole corresponding to said moveable cutting die in the base of said frame wherein said frame aligns said moveable cutting die to said hole allowing for said moveable cutting die to be moved through said hole;
a slot in said frame with said slot extending partially through said frame to accept and restrain said sheet of said material prior to said sheet of said material being punched;
a means to activate said moveable cutting die moving said cutting die to where it contacts said sheet of said material in said slot cutting said sheet of said material;
and a spring installed within said frame to return said moveable cutting die to a starting position allowing easy removal of said sheet of said material.

2. A machine for piercing sheets of material as claimed in claim 1 wherein said cutting surface is formed in a curved shape.

3. A machine for piercing sheets of material as claimed in claim 1 wherein said cutting surface is formed in a line at an angle to the top surface of said sheet of said paper.

4. A machine for piercing sheets of material as claimed in claim 1 wherein said adjustable apparatus is a threaded ring and said means to push down said moveable cutting die is threaded to match the threads on said threaded ring thereby allowing said threaded ring to be rotated and moved up and down along said means thereby adjusting and controlling the amount of travel of said moveable cutting die and acting as said stop.

5. A machine for piercing sheets of material as claimed in claim 1 wherein said adjustable apparatus is a threaded piece of hardware that is located in a matching threaded insert attached to said frame such that said threaded piece of hardware can be rotated within said threaded insert moving said threaded piece of hardware up and down thereby adjusting and controlling the amount of travel of said moveable cutting die and acting as said stop.

6. A machine for piercing sheets of material as claimed in claim 1 wherein said adjustable apparatus are a set of shims of varying thickness with said shims sized to fit said frame wherein some of said set of shims are selected to allow the desired travel of said moveable cutting die and said selected shims are placed on said frame in such a way that said selected shims act as said stop.

7. A machine for piercing sheets of material as claimed in claim 1 wherein said means to activate said moveable cutting die is a button in contact with said moveable cutting die thereby creating the necessary motion of said moveable cutting die when said button is pushed.

8. A machine for piercing sheets of material as claimed in claim 7 wherein said button is held against the force created by said spring by portions of said button.

9. A machine for piercing sheets of material as claimed in claim 1 wherein said means to activate said moveable cutting die is a thumb controlled lever in contact with said moveable cutting die thereby creating the necessary motion when said lever is pushed by said thumb and wherein said lever is held against the force created by said spring by portions of said frame.

10. A machine for piercing sheets of material as claimed in claim 1 wherein said frame consists of two arms designed to be held in the hand and squeezed to activate the moveable cutting die thereby creating the necessary motion when said two arms are squeezed.

11. A machine for piercing sheets of material as claimed in claim 1 further comprising a housing to enclose said frame and a portion of said means of activating said moveable cutting die.

12. A machine for piercing sheets of material as claimed in claim 11 wherein a portion of said adjustable apparatus is fabricated as a part of said housing.

13. A machine for piercing sheets of material as claimed in claim 1 further comprising a locking hinge mechanism located at said base of said machine where said locking hinge mechanism allows said base to be moved away from the rest of said machine following said material piercing thereby allowing for easy release of said material and said locking hinge mechanism then allows said base to be returned to the original starting position.

14. A machine for piercing sheets of material as claimed in claim 1 wherein said base of said frame contains two of said slots for said sheets of material.

15. A machine for piercing sheets of material as claimed in claim 1 wherein said moveable cutting die and said corresponding hole can be removed from said machine and replaced with another moveable cutting die with another corresponding hole.

16. A machine for piercing sheets of material comprising:
an adjustable apparatus that can be moved by hand;
the adjustable apparatus acts as a stop to the moveable cutting die containing the punch pattern thereby varying the amount of the punch pattern cut into a sheet of material being punched;
the moveable cutting die is designed with a cutting surface so that said adjustable apparatus can limit the amount of said sheet of said material cut by said cutting surface;
the adjustable apparatus can be moved to apposition so that said designed pattern of said punch is cut fully out of said sheet of said material by the movement of said moveable cutting die;
a frame which holds said adjustable apparatus and said moveable punch cutting die with said moveable cutting die held in the top of said frame and a hole corresponding to said moveable cutting die in the base of said frame wherein said frame aligns said moveable cutting die to said hole allowing for said moveable cutting die to be moved through said hole;
a slot in said frame with said slot extending partially through said frame to accept and restrain said sheet of said material prior to said sheet of said material being punched;
and a means to activate said moveable cutting die moving said cutting die to where it contacts said sheet of said material in said slot cutting said sheet of said material.

17. A machine for piercing sheets of material as claimed in claim 16 wherein said cutting surface is formed in a curved shape.

18. A machine for piercing sheets of material as claimed in claim 16 wherein said cutting surface is formed in a line at an angle to the top surface of said sheet of said material.

19. A machine for piercing sheets of material as claimed in claim 16 wherein said adjustable apparatus is a threaded ring and said means to push down said moveable cutting die is threaded to match the threads on said threaded ring thereby allowing said threaded ring to be rotated and moved up and down along said means thereby adjusting and controlling the amount of travel of said moveable cutting die and acting as said stop.

20. A machine for piercing sheets of material as claimed in claim 16 wherein said adjustable apparatus is a threaded piece of hardware that is located in a matching threaded insert attached to said frame such that said threaded piece of hardware can be rotated within said threaded insert moving said threaded piece of hardware up and down thereby adjusting and controlling the amount of travel of said moveable cutting die and acting as said stop.

21. A machine for piercing sheets of material as claimed in claim 16 wherein said adjustable apparatus are a set of shims of varying thickness with said shims sized to fit said frame wherein some of said set of shims are selected to allow the desired travel of said moveable cutting die and said selected shims are placed on said frame in such a way that said selected shims act as said stop.

22. A machine for piercing sheets of material as claimed in claim 16 wherein said means to activate said moveable cutting die is a button in contact with said moveable cutting die thereby creating the necessary motion of said moveable cutting die when said button is pushed.

23. A machine for piercing sheets of material as claimed in claim 16 wherein said means to activate said moveable cutting die is a thumb controlled lever in contact with said moveable cutting die thereby creating the necessary motion when said lever is pushed by said thumb.

24. A machine for piercing sheets of material as claimed in claim 16 wherein said frame consists of two arms designed to be held in the hand and squeezed to activate the moveable cutting die thereby creating the necessary motion when said two arms are squeezed.

25. A machine for piercing sheets of material as claimed in claim 16 further comprising a housing to enclose said frame and a portion of said means of activating said moveable cutting die.

26. A machine for piercing sheets of material as claimed in claim 25 wherein a portion of said adjustable apparatus is fabricated as a part of said housing.

27. A machine for piercing sheets of material as claimed in claim 16 further comprising a locking hinge mechanism located at the base of said machine where said locking hinge mechanism allows said base to be moved away from the rest of said machine following said material piercing thereby allowing for easy release of said material and said locking hinge mechanism then allows said base to be returned to the original starting position.

28. A machine for piercing sheets of material as claimed in claim 16 wherein said base of said frame contains two of said slots for said material.

29. A machine for piercing sheets of material as claimed in claim 16 wherein said moveable cutting die and said corresponding hole can be removed from said machine and replaced with another moveable cutting die and another corresponding hole.

30. An adjustable apparatus that can be added to existing decorative punches comprising:
said adjustable apparatus acts as a stop to the moveable cutting die containing the punch pattern thereby limiting the amount of said punch pattern cut into the sheet of material being punched;
said moveable cutting die is designed with a curved cutting surface so that said adjustable apparatus can limit the amount of paper cut by that curved surface;
said adjustable apparatus can be moved to a position so that said designed pattern of said punch is cut fully out of said sheet of material;
and said adjustable apparatus can be permanently installed on existing decorative punches.
